(19) United States
(12) Patent Application Publication
(10) Pub. No.: US 2023/0074195 A1
(43) Pub. Date: Mar. 9, 2023

(54) DEVICE FOR MEASURING MTF OF OPTICAL SYSTEM

(71) Applicant: MLOptic Corp, Redmond, WA (US)

(72) Inventors: Fei Gao, Nanjing (CN); Xinyu Peng, Nanjing (CN); Shanzeng Gao, Nanjing (CN); Hao Wu, Shanghai (CN); Jiang He, Nanjing (CN); Wei Zhou, Sammamish, WA (US)

(21) Appl. No.: 17/555,403

(22) Filed: Dec. 18, 2021

(30) Foreign Application Priority Data
Sep. 6, 2021 (CN) 202122132049.0

(51) Int. Cl. G01M 11/02; G02B 27/30

(52) U.S. Cl. CPC G01M 11/0292; G02B 27/30

(57) ABSTRACT

A device for measuring the Modulation Transfer Function (MTF) of an optical system, the device including a six-axis manipulator and an internal focusing collimator. The internal focusing collimator is fixedly installed on a flange of the manipulator. The manipulator is used to adjust the exit pupil of the internal focusing collimator and the posture of the internal focusing collimator. The tool control points of the manipulator are set at the exit pupil of the internal focusing collimator. The exit pupil of the focus collimator is located at the entrance pupil of the optical system to be measured so that the exit pupil of the inner focus collimator and the entrance pupil of the optical system to be measured are arranged in parallel. The device uses a manipulator to surround the tool point, only changing the posture and does not change the characteristics of the position transformation.

### PRIORITY CLAIM AND RELATED APPLICATIONS

This non-provisional application claims the benefit of priority from Chinese Pat. App. No. 202122132049.0 filed on Sep. 6, 2021. Said application is incorporated by reference in its entirety.

### BACKGROUND OF THE INVENTION

### 1. The Field of the Invention

The present invention relates to an optical equipment. More specifically, the present invention is directed to a device for measuring the Modulation Transfer Function (MTF) of an optical system.

### 2. Background Art

At present, the methods for measuring the MTF of an optical system include the knife-edge method, slit method and pinhole method, etc. For instance, in the knife-edge method, a checkerboard is pasted at a certain distance from the optical system and measurements are taken at several positions. A grid is a plane used to measure the MTF value at different distances from the imaging center of the optical system to be measured. MTF is a Modulation Transfer Function parameter. This method can only be used in planar measurement scenarios and cannot be used in an arc measurement as there are limitations in this method.

### SUMMARY OF THE INVENTION

In accordance with the present invention, there is provided a device for measuring the MTF of an optical system using a six-axis manipulator around a tool point to change the posture without changing the position transformation characteristics. The internal focus collimator can change the target image and the target image distance. The characteristics of the arc surface measurement application scenarios are realized.

In order to achieve the above objectives, the present provide the following technical solutions: A device for measuring the MTF of an optical system. The device includes a six-axis manipulator and an internal focusing collimator. The internal focusing collimator is fixedly installed on a flange of the six-axis manipulator. The six-axis manipulator is used to adjust the exit pupil of the internal focusing collimator and the posture of the internal focusing collimator. The tool control point is set at the exit pupil of the internal focusing collimator. The exit pupil of the internal focusing collimator is located at the entrance pupil of the optical system to be measured and the exit pupil of the internal focusing collimator is set parallel to the entrance pupil of the optical system to be measured so that the optical system can obtain internally-adjusted image of the collimator and measure the MTF on a curved surface of the optical system.

Further, the internal focus collimator adjusts the virtual working distance so that the virtual image point is at a required distance from the entrance pupil of the optical system to be measured, so as to obtain an image at the required distance.

Further, the image of the internal focusing collimator is a checkerboard or crosshair.

Further, the internal focusing collimator includes a light source, an objective lens and a reticle.

### BRIEF DESCRIPTION OF THE DRAWINGS

FIG. 1 is a schematic diagram of the device structure of an optical system for measuring MTF of the present invention.

FIG. 2 is a schematic diagram of an embodiment of the device for measuring MTF of an optical system.

### PARTICULAR ADVANTAGES OF THE INVENTION

The precision of a six-axis manipulator is higher and the measurements received due to the use of the present device are more accurate. The distance between the optical system to be measured and the image can be easily adjusted and the internal focusing collimator can be easily leveled with the optical system to be measured. The internal focusing collimator can change the image into a checkerboard or cross line so that the knife-edge method or slit method can be conveniently used to measure the optical system MTF. The manipulator can be used around the tool point to change the posture without changing the characteristics of position transformation and the internal focusing collimator can change the characteristics of the target image and the target image distance, enabling arc surface measurements of an application scenario.

### DETAILED DESCRIPTION OF A PREFERRED EMBODIMENT

The above description is only an overview of the technical solution of the present invention. In order to have a clearer understanding of the technical means of the present invention and such that they can be implemented in accordance with the content of the specification, the following is a detailed description of the preferred embodiments of the present invention with accompanying drawings.

The technical solution of the present invention will be described clearly and completely in conjunction with the accompanying drawings. Obviously, the described embodiments are part of all possible embodiments of the present invention, but not all of the embodiments. Based on the embodiments of the present invention, all other embodiments obtained by those of ordinary skill in the art without creative work shall fall within the protection scope of the present invention.

In the description of the present utility model, it should be noted that the terms “center,” “upper,” “lower,” “left,” “right,” “vertical,” “horizontal,” “inner,” “outer,” and the orientation or positional relationship of other indications are based on the orientation or positional relationship shown in the drawings and are only for the convenience of describing the present invention and simplifying the description, rather than indicating or implying that the device or element referred to, must have a specific orientation and a specific orientation and therefore cannot be understood as a limitation of the present invention. In addition, the terms “first,” “second,” and “third” are only used for descriptive purposes and cannot be understood as indicating or implying their relative importance. In the description of the present invention, it should be noted that, unless otherwise clearly stipulated and limited, the terms “installation,” “connection” and “connect” should be understood in a broad sense, for example, it can be a fixed connection or an optional detachable connection or integral connection. Each of the terms “connection” and “connect” can refer to a mechanical connection or an electrical connection and it can refer to an object being directly connected or indirectly connected through an intermediate medium and it can refer to the internal communication between two components. For those of ordinary skill in the art, the specific meaning of the above-mentioned terms in the present invention can be understood under specific circumstances. In addition, the technical features involved in the different embodiments of the present invention described below can be combined with each other as long as they do not conflict with each other.

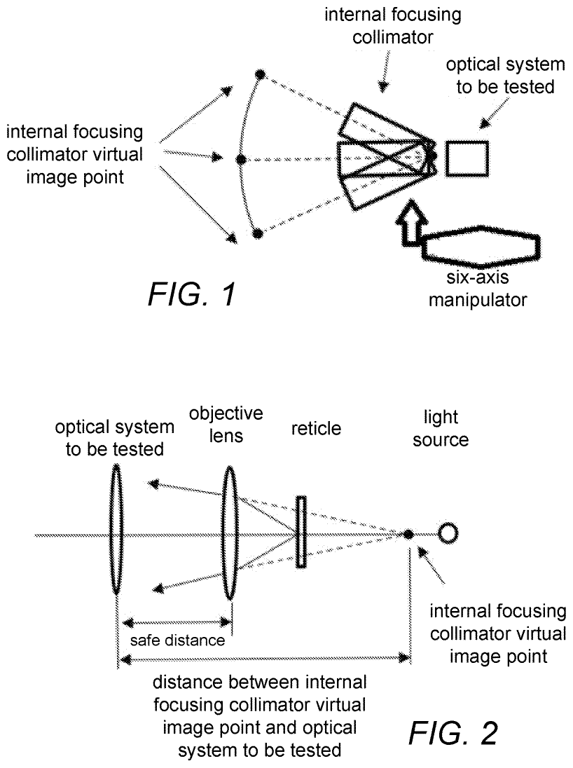

In order to achieve the above-mentioned purpose, in conjunction with FIG. 1, the present invention proposes a device for measuring the MTF of an optical system. The device includes a six-axis manipulator and an internal focus collimator. The internal focusing collimator is fixedly installed on a flange of the six-axis manipulator and the tool control point of the six-axis manipulator is set at the exit pupil of the internal focusing collimator. The internal focusing collimator is arranged along the exit pupil and parallel to the entrance pupil of the optical system to be measured and the optical system to be measured acquires the image of the internal focusing collimator and performs arc surface measurement of MTF.

The focusing collimator of the present invention adjusts the virtual working distance so that the virtual image point is at the required distance from the entrance pupil of the optical system to be measured or tested so as to obtain an image at the required distance. In one example, the internal focusing collimator is fixed on a flange of the six-axis manipulator and the five-point method is used to set the tool control points of the six-axis manipulator at the exit pupil of the internal focusing collimator and the six-axis manipulator is moved until the exit pupil of the internal focusing collimator is flush with the entrance pupil of the optical system to be measured and the internal focusing collimator is disposed at a certain safe distance from the optical system to be measured. The virtual working distance of the internal focusing collimator is adjusted to infinity and the image is observed to determine whether it is disposed at the imaging center of the optical system to be measured. If the image is disposed at the imaging center of the optical system to be measured, the optical system to be measured and the internal focusing collimator have been basically adjusted to the level and then the virtual working distance of the internal focusing collimator is adjusted to the required distance. In this way, an image of the required distance from the entrance pupil of the optical system can be obtained. According to the kinematics principle, the six-axis manipulator is operated to rotate the RxRyRz angle around the xyz axis of the tool coordinate system at the tool control point. Several points in a space at the same distance from the imaging center of the optical system to be measured can be obtained and the six-axis manipulator control software is used to record the poses of these points in the space, which is convenient for the next measurement.

Preferably, the image of the internal focusing collimator is a checkerboard to measure the MTF of the optical system by the knife-edge method, or a crosshair to measure the MTF of the optical system by the slit method.

Specifically, when the image of the internal adjustment collimator is a checkerboard to measure the MTF of the optical system using the knife-edge method, the measured optical element selects several knife-edge targets in the large-scale checkerboard and its knife-edge function is f(x,y), after passing through the optical element to be measured, f(x,y) is convolved to obtain the knife-edge spread function g(x,y) and then g(x,y) is differentiated to obtain the linear spread function in one direction, and then the optical transfer function OTF in this direction can be obtained and the MTF can be obtained.

When the image of the internal adjustment collimator is a cross line for the slit method to measure the optical system MTF, the target of the slit method is a slit, and its two-dimensional function is f(x,y), which passes through the optical system to be measured. The image function g(u,v) is obtained after the element and the OTF in one direction can be obtained by Fourier transform and the OTF in the other direction can be obtained by rotating the slit and then the MTF can be obtained.

Preferably, the internal focusing collimator includes a light source, an objective lens and a reticle. Specifically, the internal focusing collimator is aligned with the optical element of the optical system to be measured. When the light emitted by the light source reaches the objective lens through the reticle, the virtual working distance of the objective lens can be changed to form a virtual distance from the optical element to be measured. The distance of the image point is adjusted according to the virtual working distance of the objective lens.

The technical features of the above-mentioned embodiments can be combined arbitrarily. In order to make the description concise, not all possible combinations of the various technical features in the above-mentioned embodiments are described. However, as long as there is no contradiction in the combination of these technical features, all possible combinations should be considered as the scope of this specification.

The above-mentioned embodiment only expresses one embodiment of the present invention and its description is more specific and detailed, but it should not be understood as a limitation on the scope of the present invention. It should be pointed out that for those of ordinary skill in the art, without departing from the concept of the present invention, several modifications and improvements can be made, and all of these fall within the protection scope of the present invention. Therefore, the scope of protection of the present invention should be subject to the appended claims.

What is claimed herein is:

1. A device for measuring the MTF of an optical system, said device comprises a six-axis manipulator, an internal focusing collimator fixedly installed on the six-axis manipulator, the six-axis manipulator is configured to adjust an exit pupil of said internal focusing collimator and the posture of said internal focusing collimator, said exit pupil of said internal focusing collimator is configured to be located at an entrance pupil of the optical system and said exit pupil of said internal focusing collimator is set parallel to the entrance pupil of the optical system so that the optical system can obtain an internally adjusted image of the collimator and measure the Modulation Transfer Function (MTF) on a curved surface of the optical system.

2. The device according to claim 1, wherein said internal focusing collimator is configured to adjust the virtual working distance so that the virtual image point is disposed at a required distance from the entrance pupil of the optical system to obtain the image at the required distance.

3. The device according to claim 1, wherein the image of said internal focusing collimator is an image selected from the group consisting of a checkerboard and a crosshair.

4. The device according to claim 1, wherein said internal focusing collimator comprises a light source, an objective lens and a reticle, said internal focus collimator is configured to be aligned with optical elements of the optical system, wherein when a light emitted by said light source reaches said objective lens through said reticle, by changing the virtual working distance of the objective lens, a virtual image point with a different distance from the optical elements is formed, the distance of the image is adjusted according to the virtual working distance of the objective lens.
